(19) United States
(12) Patent Application Publication
(10) Pub. No.: US 2026/0313749 A1
(43) Pub. Date: Oct. 8, 2026

(54) METHOD AND APPARATUS FOR MANAGING A USER EQUIPMENT FOR MULTICAST BROADCAST SERVICE MULTICAST RECEPTION

(71) Applicant: Samsung Electronics Co., Ltd., Gyeonggi-do (KR)

(72) Inventor: Vinay Kumar SHRIVASTAVA, Bangalore (IN)

(21) Appl. No.: 19/100,743

(22) PCT Filed: Aug. 1, 2023
(86) PCT No.: PCT/KR2023/011187

§ 371 Date: Feb. 3, 2025

(30) Foreign Application Priority Data
Aug. 1, 2022 (IN) 202241044071
Jul. 14, 2023 (IN) 202241044071

(51) Int. Cl. H04W 76/40; H04W 76/10; H04W 76/30

(52) U.S. Cl. CPC H04W 76/40; H04W 76/10; H04W 76/30

(57) ABSTRACT

The disclosure relates to a 5G or 6G communication system for supporting a higher data transmission rate. The present disclosure provides a method (200) for multicast broadcast service (MBS) multicast reception in a radio resource control (RRC)_INACTIVE state. The method includes receiving (201), by a UE from a network associated with the UE, a frequency resource configuration (multicast-bwp-inactive-config) from a plurality of frequency resource configurations for the MBS multicast reception in the RRC_INACTIVE state. The plurality of frequency resource configurations includes a bandwidth part (BWP) configuration and a common frequency resource (CFR) configuration. The method further includes performing (203), by the UE, one activity from a plurality of activities for one or more relevant MBS multicast sessions in the RRC_INACTIVE state, based on the received frequency resource configuration. The plurality of activities includes monitoring a physical downlink control channel (PDCCH) and receiving a physical downlink shared channel (PDSCH) in the RRC_INACTIVE state.

### TECHNICAL FIELD

The present invention generally relates to wireless communication networks, and more particularly, to a method and an apparatus for managing a user equipment (UE) for multicast broadcast service (MBS) multicast reception in a radio resource control (RRC)_INACTIVE state.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mm Wave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mm Wave, supporting numerologies (for example, operating multiple subcarrier spacings) for efficiently utilizing mm Wave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

New radio (NR) MBS services can refer to multicast services where intended common contents are targeted to a group of User Equipment (UEs) that have joined a multicast group in a multicast coverage area and broadcast services where intended contents may be targeted to all the UEs in a broadcast coverage area. This coverage area can be associated with one radio cell or more than one radio cell. One example of an application that may use broadcast service is a TV broadcasting service and that for multicast service is a mission critical push to talk (MCPTT) or a conference call.

In the legacy system (i.e., 3GPP Release 17 MBS), the UEs could receive multicast services only in an RRC_CONNECTED state. The RRC_CONNECTED state refers to a state of the UEs in which the UEs can transmit and receive signaling and traffic data. Further, there are mechanisms for bandwidth part (BWP) based unicast reception in the RRC_CONNECTED state. The BWP is a part of the total channel bandwidth configured for a serving cell of the UE that is used for the UE's operation. Usually, a serving cell is configured with multiple BWPs and among them, one of the BWPs may be activated and used (also termed as active BWP). Active BWP for the UE may be deactivated by the network. Active BWP for the UE may be switched to another BWP by the network. Accordingly, the BWP is a contiguous set of physical resource blocks (PRB), selected from a contiguous subset of the common resource blocks for a given numerology.

Now, in the RRC_CONNECTED state, typically there is a unicast active BWP on which unicast services can be received. So, when the multicast services were introduced in the RRC_CONNECTED state, a concept of common frequency resource (CFR) is introduced. In general, the CFR is a range of frequency resources that is linked with the unicast active BWP. Thus, the UE receives unicast transmission in an active BWP and multicast transmission is received over the CFR which is associated with the unicast active BWP, in the RRC_CONNECTED state. However, there may also be UEs that can receive multicast session(s) in an RRC_INACTIVE state. The RRC Inactive state allows the UE to return to the RRC_CONNECTED state, when needed and start transferring unicast application data or signaling messages with minimal latency.

A significant issue that concerns the UEs for which multicast session is being received in the RRC_INACTIVE state is the configuration and operation of the BWP/CFR over which the UE needs to receive one or more multicast session(s). In 3GPP NR Release 18, in order to support a large number of multicast UEs, the multicast reception is also required to be enabled in the RRC_INACTIVE state (to support more UEs than active connections possible in the system). These UEs need to be appropriately and efficiently configured and operated for the BWP/CFR to receive multicast reception in the RRC_INACTIVE state. There is no specified mechanism for BWP/CFR configuration and operation for multicast reception in the RRC_INACTIVE state.

Therefore, there is a need to define techniques for the multicast UEs to appropriately configure and operate BWP or CFR in the RRC_INACTIVE state.

### DISCLOSURE OF INVENTION

### Technical Problem

The present invention has been made to address at least the above problems and/or disadvantages and to provide at least the advantages described below. Accordingly, an aspect of the present invention provides a method and an apparatus for managing a user equipment for MBS multicast reception.

### Solution to Problem

According to an embodiment of the present disclosure, the present disclosure matter describes a method for multicast broadcast service (MBS) multicast reception in a radio resource control (RRC)_INACTIVE state. The method may includes receiving, by a UE from a network associated with the UE, a frequency resource configuration (multicast-bwp-inactive-config) from a plurality of frequency resource configurations for the MBS multicast reception in the RRC_INACTIVE state. The plurality of frequency resource configurations includes a bandwidth part (BWP) configuration and a common frequency resource (CFR) configuration. The method further includes performing, by the UE, one activity from a plurality of activities for one or more relevant MBS multicast sessions in the RRC_INACTIVE state, based on the received frequency resource configuration. The plurality of activities includes monitoring a physical downlink control channel (PDCCH) and receiving a physical downlink shared channel (PDSCH) in the RRC_INACTIVE state.

According to some embodiments, a system for managing the UE for multicast broadcast service (MBS) multicast reception in the radio resource control (RRC)_INACTIVE state is disclosed. The system may includes a memory and a processor coupled to the memory and an input/output (I/O) interface. The processor is configured to receive from a network associated with the UE, the frequency resource configuration (multicast-bwp-inactive-config) for the MBS multicast reception in the RRC_INACTIVE state from the plurality of frequency resource configurations. The plurality of frequency resource configurations includes the bandwidth part (BWP) configuration and the common frequency resource (CFR) configuration. The processor is further configured to perform one activity from the plurality of activities for one or more relevant MBS multicast sessions in the RRC_INACTIVE state, based on the received frequency resource configuration. The plurality of activities includes monitoring the physical downlink control channel (PDCCH) and receiving the physical downlink shared channel (PDSCH) in the RRC_INACTIVE state.

To further clarify the advantages and features of the present invention, a more particular description of the invention will be rendered by reference to specific embodiments thereof, which is illustrated in the appended drawings. It is appreciated that these drawings depict only typical embodiments of the invention and are therefore not to be considered limiting of its scope. The invention will be described and explained with additional specificity and detail with the accompanying drawings.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### Advantageous Effects of Invention

Advantages, and salient features of the invention will become apparent to those skilled in the art from the following detailed description, which, taken in conjunction with the annexed drawings, discloses exemplary embodiments of the invention. For more enhanced communication system, there is a need for a method and an apparatus for managing a user equipment for MBS multicast reception.

### BRIEF DESCRIPTION OF DRAWINGS

These and other features, aspects, and advantages of the present invention will become better understood when the following detailed description is read with reference to the accompanying drawings in which like characters represent like parts throughout the drawings, wherein:

FIG. 1 illustrates a block diagram of a system for managing a user equipment (UE) for multicast broadcast service (MBS) multicast reception in a radio resource control (RRC)_INACTIVE state, in accordance with an embodiment of the present disclosure;

FIG. 2 illustrates a flow diagram of a method for managing the UE for the MBS multicast reception in the RRC_INACTIVE state, in accordance with an embodiment of the present disclosure;

FIG. 3A illustrates an operational flow for an inactivity timer (multicast-bwp-inactivitytimer) management for the MBS multicast reception in the RRC_INACTIVE state, in accordance with an embodiment of the present disclosure;

FIG. 3B illustrates an operational flow for an inactivity timer (multicast-bwp-inactivitytimer) management for the MBS multicast reception in the RRC_INACTIVE state, in accordance with an embodiment of the present disclosure;

FIG. 4 illustrates an exemplary method for the multicast reception in the RRC_INACTIVE state using the frequency resource configuration, in accordance with an embodiment of the present disclosure; and

FIG. 5 illustrates a signal flow diagram of an exemplary method for receiving multicast session in the RRC_INACTIVE state using the frequency resource configuration, in accordance with an embodiment of the present disclosure.

### MODE FOR THE INVENTION

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are explanatory of the invention and are not intended to be restrictive thereof.

Reference throughout this specification to “an aspect”, “another aspect” or similar language means that a particular feature, structure, or characteristic described in connection with the embodiment is included in at least an embodiment of the present invention. Thus, appearances of the phrase “in an embodiment”, “in another embodiment”, and similar language throughout this specification may, but do not necessarily, all refer to the same embodiment.

The terms “comprise”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components preceded by “comprises . . . a” does not, without more constraints, preclude the existence of other devices or other sub-systems or other elements or other structures or other components or additional devices or additional sub-systems or additional elements or additional structures or additional components.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks that carry out a described function or functions. These blocks, which may be referred to herein as units or modules or the like, are physically implemented by analog or digital circuits, such as logic gates, integrated circuits, microprocessors, microcontrollers, memory circuits, passive electronic components, active electronic components, optical components, hardwired circuits, or the like, and may optionally be driven by firmware and software. The circuits may, for example, be embodied in one or more semiconductor chips, or on substrate supports, such as printed circuit boards and the like. The circuits constituting a block may be implemented by dedicated hardware, by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the invention. Likewise, the blocks of the embodiments may be physically combined into more complex blocks without departing from the scope of the invention.

The accompanying drawings are used to help easily understand various technical features and it should be understood that the embodiments presented herein are not limited by the accompanying drawings. As such, the present disclosure should be construed to extend to any alterations, equivalents, and substitutes in addition to those which are particularly set out in the accompanying drawings. Although the terms first, second, etc. may be used herein to describe various elements, these elements should not be limited by these terms. These terms are generally only used to distinguish one element from another.

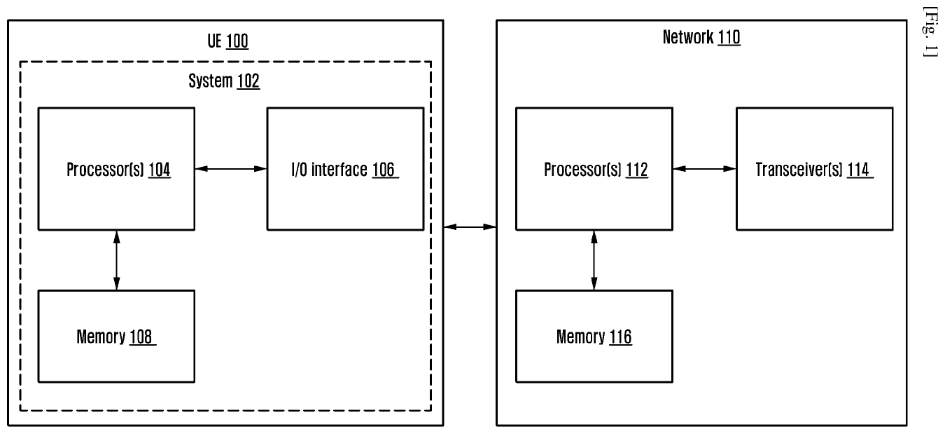

Referring now to the drawings, and more particularly to FIGS. 1 to 3A-3B, where similar reference characters denote corresponding features consistently throughout the figures, there are shown preferred embodiments.

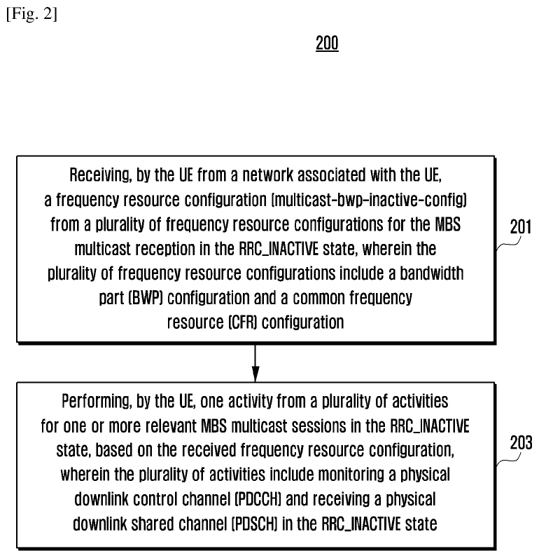

FIG. 1 illustrates a block diagram of a system 102 for managing a user equipment (UE) for multicast broadcast service (MBS) multicast reception in a radio resource control (RRC)_INACTIVE state, in accordance with an embodiment of the present disclosure. FIG. 2 illustrates a flow diagram of a method 200 for managing the UE for the MBS multicast reception in the RRC_INACTIVE state, in accordance with an embodiment of the present disclosure. For the sake of brevity, FIGS. 1 and 2 are explained in conjunction with each other.

In an embodiment of the present disclosure, the one or more MBS multicast sessions refer to data sessions associated with multicast services and broadcast services. The system 102 receives a frequency resource configuration to perform one or more activities in the RRC_INACTIVE state in order to operate the data sessions.

Referring to FIG. 1, the system 102 may include one or more processors 104, an Input/Output (I/O) interface 106 (e.g., a communicator or communication interface, or a transceiver), and a memory 108 (e.g., storage). In an embodiment, the I/O interface 106 may perform functions for transmitting and receiving signals via a wireless channel.

As an example, the one or more processors 104 may be a single processing unit or a number of units, all of which could include multiple computing units. The one or more processors 104 may be implemented as one or more microprocessors, microcomputers, microcontrollers, digital signal processors, central processing units, state machines, logic circuitries, and/or any devices that manipulate signals based on operational instructions. Among other capabilities, the one or more processors 104 are configured to fetch and execute computer-readable instructions and data stored in the memory. At this time, one or a plurality of processors may be a general-purpose processor, such as a central processing unit (CPU), an application processor (AP), or the like, a graphics-only processing unit such as a graphics processing unit (GPU), a visual processing unit (VPU), and/or an artificial intelligence (AI)-dedicated processor such as a neural processing unit (NPU). The one or more processors 104 may control the processing of the input data in accordance with a predefined operating rule or AI model stored in the non-volatile memory and the volatile memory, i.e., memory 108. The predefined operating rule or artificial intelligence model is provided through training or learning. In an embodiment, the processor 104 may perform one or more functions/methods, as discussed throughout the present disclosure.

The memory 108 may include any non-transitory computer-readable medium known in the art including, for example, volatile memory, such as static Random-Access memory (SRAM) and dynamic random access memory (DRAM), and/or non-volatile memory, such as read-only memory (ROM), erasable programmable ROM, flash memories, hard disks, optical disks, and magnetic tapes. In an embodiment, the memory 108 may store the received frequency resource configuration such as different BWP configurations and CFR configurations. Accordingly, the processor 104 may access the memory to retrieve the frequency resource configuration and monitors a physical downlink control channel (PDCCH) or receives a physical downlink shared channel (PDSCH) in the RRC_INACTIVE state based on the received frequency resource configuration.

Some example embodiments disclosed herein may be implemented using processing circuitry. Further, some example embodiments disclosed herein may be implemented using at least one software program running on at least one hardware device and performing management functions to control the elements.

In an embodiment of the present disclosure, the one or more processors 104 include a communication processor (CP) and an application processor (AP). For example, the CP may include a modem. The CP is configured to handle Layer 2 and other protocols. In an embodiment of the present disclosure, the AP is associated with upper layers, such as a network layer, a transport layer, and an application layer.

Further, the one or more processors 104 may be disposed in communication with one or more I/O devices via the I/O interface 106. The I/O interface 106 may employ communication code-division multiple access (CDMA), high-speed packet access (HSPA+), global system for mobile communications (GSM), long-term evolution (LTE), WiMax, 5G New Radio (NR), 6G or the like, etc.

Using the I/O interface 106, the system 102 may communicate with one or more other I/O devices, such as other UEs. For example, the input device may be an antenna, microphone, touch screen, touchpad, storage device, transceiver, video device/source, etc. The output devices may be a printer, fax machine, video display (e.g., cathode ray tube (CRT), liquid crystal display (LCD), light-emitting diode (LED), plasma, Plasma Display Panel (PDP), Organic light-emitting diode display (OLED) or the like), audio speaker, etc.

The one or more processors 104 may be disposed in communication with a communication network 110 via a network interface. In an embodiment, the network interface may be the I/O interface 106. The network interface may connect to the communication network 110 to enable connection of the system 102 with the outside environment. The network interface may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 110 may include, without limitation, a direct interconnection, local area network (LAN), wide area network (WAN), wireless network (e.g., using Wireless Application Protocol), the Internet, a wireless network, and the like.

In an embodiment of the present disclosure, the system 102 is communicatively coupled to a network 110 for receiving the frequency resource configuration from the network 110, as shown in FIG. 1. In an embodiment, the network 110 may be one of a plurality of cellular networks (such as a 3G, 4G, a 5G or pre-5G, 6G network or any future wireless communication network). In an embodiment, the network 110 may be one of a base station of the network 110.

Referring to the FIG. 1, the network 110 may include a processor(s) 112, a transceiver(s) 114 and a memory 116. However, all of the illustrated components are not essential. The network 110 may be implemented by more or less components than those illustrated in FIG. 1. In addition, the processor(s) 112 and the transceiver(s) 114 and the memory 116 may be implemented as a single chip according to another embodiment.

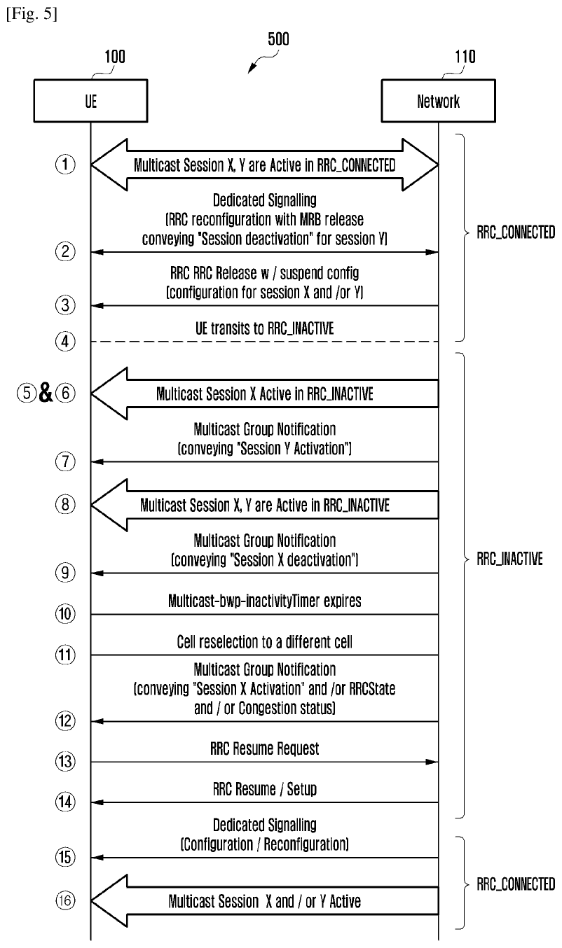

The network 110 may correspond to the network described in the present disclosure. For example, the network 110 may correspond to the network in FIG. 5.

The aforementioned components will now be described in detail.

The processor(s) 112 may include one or more processors or other processing devices that control the proposed function, process, and/or method. Operation of the network 110 may be implemented by the processor(s) 112.

The transceiver(s) 114 may include a RF transmitter for up-converting and amplifying a transmitted signal, and a RF receiver for down-converting a frequency of a received signal. However, according to another embodiment, the transceiver(s) 114 may be implemented by more or less components than those illustrated in components.

The transceiver(s) 114 may be connected to the processor(s) 112 and transmit and/or receive a signal. The signal may include control information and data. In addition, the transceiver(s) 114 may receive the signal through a wireless channel and output the signal to the processor(s) 112. The transceiver(s) 114 may transmit a signal output from the processor(s) 112 through the wireless channel.

The memory 116 may store the control information or the data included in a signal obtained by the network 110. The memory 116 may be connected to the processor(s) 112 and store at least one instruction or a protocol or a parameter for the proposed function, process, and/or method. The memory 116 may include read-only memory (ROM) and/or random access memory (RAM) and/or hard disk and/or CD-ROM and/or DVD and/or other storage devices.

In an embodiment, the configuration of the system 102 may be understood as a part of the configuration of the UE 100. In an exemplary embodiment of the present disclosure, the UE 100 may correspond to a smartphone, a laptop computer, a desktop computer, a wearable device, a television and the like. It should be noted that the various embodiments have been defined as the system 102 being a part of the UE 100. Accordingly, the various embodiments have been defined as being performed by the UE 100. However, in an alternate embodiment, the system 102 may be connected to the UE 100.

Referring to FIG. 2, in an embodiment, the method as defined in reference to FIG. 2 may be performed by the UE 100. In an embodiment, the UE 100 may be capable of and/or configured to receive multicast in the RRC_INACTIVE state. For example, the UE 100 that supports 3GPP Release 18 MBS may be capable and/or configured to receive multicast in the RRC_INACTIVE state. As shown in FIG. 2, at step 201, the method 200 may include receiving a frequency resource configuration (multicast-bwp-inactive-config) from a plurality of frequency resource configurations for the MBS multicast reception in the RRC_INACTIVE state. In an embodiment, the UE 100 may receive the frequency resource configuration from the network 110. In an embodiment, the plurality of frequency resource configurations include at least one of a bandwidth part (BWP) configuration and a common frequency resource (CFR) configuration. The BWP configuration provides a corresponding frequency span where the UE 100 can receive the relevant transmission (e.g., unicast active BWP for unicast transmission). The CFR is the common frequency resource which is typically configured as a portion of the BWP and then allocated to the UE (e.g., MBS CFR for MBS transmission can be configured that is linked to a unicast active BWP). Accordingly, the terms “frequency resource configuration” and “BWP/CFR” are identical and may be used interchangeably in the context of the present disclosure.

Further, in an embodiment, the frequency resource configuration (multicast-bwp-inactive-config) comprises at least one of a time division duplex (TDD) uplink-downlink (UL-DL) configuration, an initial DL BWP, an active DL BWP, a default DL BWP, an initial UL BWP, an active UL BWP, explicit or implicit identities for the BWPs or CFRs, physical random access channel (PRACH) occasions or configurations, a multicast-bwp-inactivitytimer, a slot format indicator, a number of hybrid automatic repeat request (HARQ) processes, a number of contiguous physical resource blocks (PRBs) and starting PRB for the CFR (e.g. for the multicast MCCH and MTCH reception), a configuration for time domain resource allocation for multicast reception in RRC_INACTIVE, a configuration for frequency domain resource allocation for multicast reception in RRC_INACTIVE, an indication or configuration (for example, MBS radio bearer configuration) for the MBS session(s) which are to be continued in the RRC_INACTIVE state, an indication or configuration for the MBS session(s) which are not to be continued in the RRC_INACTIVE state, MBS sessions which are to be released in the RRC_INACTIVE state (i.e., not continued in the RRC_INACTIVE state), and MBS sessions which are to be modified in the RRC_INACTIVE state (i.e., one or more configuration parameters for the MBS sessions are changed for reception in RRC_INACTIVE state).

At step 203, the method 200 may include performing one activity from a plurality of activities for one or more relevant MBS multicast sessions in the RRC_INACTIVE state, based on the received frequency resource configuration. In an embodiment, the one or more relevant MBS multicast session are data sessions pertaining to the multicast services in which the UE is interested in. In an embodiment, the plurality of activities includes monitoring a physical downlink control channel (PDCCH) and receiving a physical downlink shared channel (PDSCH) in the RRC_INACTIVE state. In an embodiment, the PDCCH and the PDSCH are addressed to a group radio network temporary identifier (G-RNTI) or a group configured scheduling radio network temporary identifier (G-CS-RNTI). In particular, the PDCCH and PDSCH channels are scrambled by the G-RNTI/G-CS-RNTI. The UEs which are interested to receive the relevant multicast sessions receive these channels, i.e., the UEs monitor these channels and determine that the corresponding identifiers are matching and then further receive/process the contents over the channels.

Referring back to step 201, the BWP configuration may further include a plurality of BWP configurations. For example, in an embodiment, the BWP configuration may include BWP configuration same as a unicast dedicated active downlink (DL) BWP configuration for the UE 100 in an RRC_CONNECTED state, wherein the BWP configuration enables the UE 100 to receive the one or more relevant MBS sessions in the RRC_INACTIVE state. In particular, the CBWP configuration for usage in the RRC_INACTIVE state for multicast reception is the same as the unicast dedicated active downlink BWP configuration the UE 100 is utilizing to receive multicast session(s) in an RRC_CONNECTED state. The UE 100 monitors for the PDCCH addressed to the G-RNTI or the G-CS-RNTI and/or receives the PDSCH addressed to the G-RNTI or the G-CS-RNTI over the unicast dedicated Active DL BWP configuration for the one or more relevant/interested MBS multicast session(s) in the RRC_INACTIVE state.

In another embodiment, the BWP configuration may include an initial downlink (DL) BWP configuration. The initial downlink BWP configuration enables the UE 100 to receive system information and paging in the RRC_INACTIVE state. The system information enables the UE to receive configuration for the multicast MBS control channel (MCCH) and MBS traffic channel (MTCH) channels to operate and receive multicast in RRC_INACTIVE state (e.g. for receiving session deactivation notification, MBS multicast session configuration and MBS multicast traffic). The paging enables the UE to receive group paging or notification for the multicast sessions in RRC_INACTIVE state (e.g. session activation notification). The UE 100 monitors for the PDCCH addressed to the G-RNTI or the G-CS-RNTI and/or receives the PDSCH addressed to the G-RNTI or the G-CS-RNTI over the initial downlink BWP configuration for the one or more relevant/interested MBS multicast session(s) in the RRC_INACTIVE state. In an embodiment, the network 110 may define the initial downlink BWP configuration based on a plurality of configurable parameters related to frequency resources of the frequency resource configuration. In an embodiment, the plurality of configurable parameters may include at least one of a number of contiguous physical resource blocks (PRBs), a starting PRB, and a sub-carrier spacing (SCS) for the frequency resource configuration.

In another embodiment, the BWP configuration may include a default downlink BWP configuration when downlink reception is below a predetermined threshold in the RRC_INACTIVE state. For example, the UE 100 may fall back to the default BWP configuration when there is inactivity for UE DL traffic/reception. However, if the default BWP configuration is not configured for the UE 100, the UE 100 may switch to the initial DL BWP configuration. In an embodiment, the predetermined threshold for the downlink reception may be defined by the network 110. In a further embodiment, the network 110 may define the default downlink BWP configuration based on the plurality of configurable parameters. The UE 100 monitors for the PDCCH addressed to the G-RNTI or the G-CS-RNTI and/or receives the PDSCH addressed to the G-RNTI or the G-CS-RNTI over the default DL BWP configuration for the one or more relevant/interested MBS multicast session(s) in the RRC_INACTIVE state.

In another embodiment, the BWP configuration may include a downlink MBS BWP configuration. In an embodiment, the downlink MBS BWP configuration is the same as an MBS CFR configuration for the UE 100 in the RRC_CONNECTED state. In particular, the downlink MBS BWP configuration has the same resources as the MBS CFR configuration the UE 100 is utilizing to receive multicast session(s) in the RRC_CONNECTED state. In other words, the full unicast-dedicated active downlink BWP configuration is not monitored or utilized, and MBS BWP may be only the MBS CFR part of the unicast-dedicated active BWP. Further, the UE 100 monitors for the PDCCH addressed to the G-RNTI or the G-CS-RNTI and/or receives the PDSCH addressed to the G-RNTI or the G-CS-RNTI over the downlink MBS BWP configuration for the one or more relevant/interested MBS multicast session(s) in the RRC_INACTIVE state.

In another embodiment, the CFR configuration may include a first MBS CFR configuration where the first MBS CFR configuration enables the UE 100 to receive the one or more relevant MBS multicast sessions in the RRC_INACTIVE state. In an embodiment, the first MBS CFR configuration is linked or associated with the initial downlink BWP configuration. In particular, the first MBS CFR is configured to be one of a smaller than, larger than, or equal to an initial downlink BWP defined in the initial downlink BWP configuration. In an embodiment, the network 110 may define the first MBS CFR configuration based on the plurality of configurable parameters. The first MBS CFR configuration may be indicated by providing the number of contiguous PRBs and the starting PRB for the CFR. The UE 100 monitors for the PDCCH addressed to the G-RNTI or the G-CS-RNTI and/or receives the PDSCH addressed to the G-RNTI or the G-CS-RNTI over the first MBS CFR associated with the initial downlink BWP configuration for the one or more relevant/interested multicast session(s) in the RRC_INACTIVE state.

In another embodiment, the CFR configuration may include a second MBS CFR configuration where the second MBS CFR configuration enables the UE 100 to receive the one or more relevant MBS multicast sessions in the RRC_INACTIVE state. In an embodiment, the second MBS CFR configuration is linked or associated with the unicast dedicated active downlink BWP configuration for the UE 100 in an RRC_CONNECTED state. The UE 100 monitors for the PDCCH addressed to the G-RNTI or the G-CS-RNTI and/or receives the PDSCH addressed to the G-RNTI or the G-CS-RNTI over the second MBS CFR for the one or more relevant/interested multicast session(s) in the RRC_INACTIVE state.

In another embodiment, the CFR configuration may include a third MBS CFR configuration where the third MBS CFR configuration enables the UE 100 to receive the one or more relevant MBS multicast sessions in the RRC_INACTIVE state. In an embodiment, the third MBS CFR configuration is the same as a CFR configuration for broadcast service and is linked or associated with the initial downlink BWP configuration. In particular, the third MBS CFR is configured to be one of a smaller than, larger than, or equal to the initial downlink BWP defined in the initial downlink BWP configuration. In an embodiment, the network 110 may define the first MBS CFR configuration based on the plurality of configurable parameters. The UE 100 monitors for the PDCCH addressed to the G-RNTI or the G-CS-RNTI and/or receives the PDSCH addressed to the G-RNTI or the G-CS-RNTI over the third MBS CFR associated with the initial downlink BWP for the one or more relevant/interested multicast session(s) in the RRC_INACTIVE state.

In an embodiment, only unicast-dedicated active DL BWP or MBS CFR linked to unicast-dedicated active DL BWP is continued in the RRC_INACTIVE state. However, corresponding unicast dedicated active UL BWP is not continued in the RRC_INACTIVE state (i.e., the UE 100 does not maintain the dedicated active UL BWP and rather uplink (UL) transmissions e.g., physical random access channel (PRACH) transmission, can be performed in the initial UL BWP).

In an embodiment, both unicast-dedicated active DL BWP or MBS CFR linked to unicast-dedicated active DL BWP and corresponding unicast-dedicated active UL BWP are continued in the RRC_INACTIVE state (i.e., the UE 100 also maintains the dedicated active UL BWP and UL transmissions e.g., PRACH transmission, or HARQ feedback, if any, can be performed in the active UL BWP).

In an embodiment, the UE 100 availing multicast in the RRC_INACTIVE state may also need to access the floor (i.e., accessing shared medium for transmission for Mission-Critical Push-to-Talk service when the UE is required to send some uplink traffic) and transmit traffic in the uplink direction. For this purpose, the UE 100 may initiate a PRACH transmission to the network 110 and quickly resume the RRC connection and come to the RRC_CONNECTED state. If the Physical Random Access Channel (PRACH) occasions are configured and utilized on the active UL BWP to transmit PRACH preambles, the network 110 gets notified of the need for the UE 100 and addresses the request for RRC state transition promptly and reliably. If the PRACH occasions are not configured on the active UL BWP, the UE 100 does PRACH transmission on the initial UL BWP.

In an embodiment, the UE 100 can use at least one of a pre-specified or a special preamble to indicate to the network 110 the need to access the floor and transmit multicast traffic in the uplink direction. The network 110 can therefore address the request for RRC state transition promptly and reliably.

Referring back to step 201, in an embodiment, the UE 100 may receive the frequency resource configuration for the multicast reception in RRC_INACTIVE state in an RRC signalling message comprising at least one of an RRC reconfiguration message (e.g. reuse of RRC reconfiguration parameters for RRC_INACTIVE or comprising specifically indicated parameters in the message for reuse in RRC_INACTIVE or a reduced set of parameters provided specifically for RRC_INACTIVE), an RRCRelease with SuspendConfig message, and a broadcasted signaling message comprising at least one of a system information block (SIB) or MBS control channel (MCCH) message. In the case of the RRC signalling message (e.g. RRC reconfiguration message), the network 110 may reuse RRC reconfiguration parameters for the RRC_INACTIVE state or may specifically indicate parameters in the RRC reconfiguration message for reuse in the RRC_INACTIVE state or may indicate a reduced set of parameters provided specifically for the RRC_INACTIVE state. In an embodiment, the reduced set of parameters may refer to comparatively lesser parameters that may be required for multicast reception in RRC_INACTIVE state than that for the multicast reception in RRC_CONNECTED state. The RRC signalling message may also include an indication or configuration (MBS radio bearer configuration) for the multicast session(s) which are to be continued in the RRC_INACTIVE state and/or multicast sessions that are to be released (i.e., not to be continued in the RRC_INACTIVE state) and/or multicast sessions which are to be modified (i.e., one or more configuration parameters for the multicast session(s) are changed for reception in the RRC_INACTIVE state).

In an embodiment, the UE 100 which is configured/capable to receive multicast in the RRC_INACTIVE state receives the multicast session through a broadcast delivery in the RRC_INACTIVE state from the network 110. This may be required due to a large number of UEs availing or interested to avail multicast services in the cell causing (potential) congestion in the network 110 and the network 110 may decide to transit one or more UEs out of the RRC_CONNECTED state and provide multicast service through a broadcast delivery approach. That is, the multicast session is converted to the broadcast service when the UE 100 needs to be transitioned to the RRC_INACTIVE state and/or an RRC_IDLE state and is provided by reusing the broadcast delivery framework of the MBS (which includes System Information Block (SIB) or MBS Control Channel (MCCH) based broadcast signaling and configuration).

In an embodiment, the UE 100 may be switched across the plurality of frequency resource configurations, i.e., different BWP/CFR configurations for multicast reception in RRC_INACTIVE by indicating the applicable BWP identity/CFR identity/a number of contiguous physical resource blocks (PRBs) and a starting PRB for the CFR in the PDCCH through a downlink control information (DCI) signaling. The BWP identity or CFR identity relates to the at least one of the configured BWPs or CFRs to the UE for multicast reception in RRC_INACTIVE state configured through RRC signaling message.

In an embodiment, the UE 100 may dynamically receive an indication for frequency domain resources allocation and time domain resources allocation for reception of MBS multicast services in the RRC_INACTIVE state in a PDCCH DCI based on the received frequency resource configuration in the RRC signalling. For example, a scheduling DCI format 4_1 used in the RRC_CONNECTED state is reused for the UE 100 in the RRC_INACTIVE state. In another embodiment, the UE 100 receiving multicast in the RRC_INACTIVE state may not apply certain dedicated parameters signaled in the received DCI format 4_1 but may apply these certain dedicated parameters for receiving multicast in RRC_CONNECTED only. That is, the UE receiving multicast in RRC_INACTIVE state invalidates or ignores these dedicated parameters included in the DCI. In an embodiment, these dedicated parameters may include but not limited to, at least one parameter of physical uplink control channel (PUCCH) resource indicator, PDSCH-to-hybrid automatic repeat request (HARQ)_feedback timing indicator, downlink assignment index, etc. The allocated resources are mapped to one of the plurality of frequency resource configuration, i.e., BWP or CFR configurations as applicable for the one or more relevant MBS multicast session reception in the RRC_INACTIVE state.

In a further embodiment, if the UE 100 is configured and/or capable to receive the one or more relevant MBS multicast sessions in the RRC_INACTIVE state and the UE 100 has only deactivated MBS multicast session(s), the UE 100 may be switched to and/or operated in the initial DL BWP. In particular, the UE 100 may continue monitoring for a group notification and/or a group paging in the initial DL BWP. When the UE 100 receives the group notification or group paging with activation of at least one relevant/interested MBS multicast session, the UE 100 is switched and/or operated to one of the BWP or CFR configurations as discussed in earlier embodiments for MBS multicast session reception in the RRC_INACTIVE state. Further, when UE 100 receives the group notification with the deactivation of the last activated MBS multicast session and/or due to inactivity of the MBS multicast data reception, the UE 100 is switched to and/or operated on the initial DL BWP.

In an embodiment, the UE 100 may have the capability to support multicast reception in the RRC_INACTIVE state only if the initial DL BWP configuration has overlapping with the unicast dedicated active DL BWP configuration or the MBS CFR configuration (e.g., the UE 100 has a limitation to receive one BWP at a time). The UE 100 may indicate in a UE capability message about this capability limitation or support to the network 110. The network 110 may consider this capability information while determining whether to transition the UE 100 to the RRC_INACTIVE state. For example, the network 110 may not transit the UE 100 to the RRC_INACTIVE for multicast reception, and/or the network 110 may configure the unicast dedicated active DL BWP configuration or the MBS CFR configuration appropriately to the UE 100, based on the capability information received from the UE 100. Further, the UE 100 may initiate an RRC connection resume request when the UE 100 receives such a limited configuration in the RRC_INACTIVE state and may transition to the RRC_CONNECTED state and/or send an indication for UE's multicast interest or information to the network 110 by a signaling message e.g., MBS interest indication or UE assistance information message.

In another embodiment, the UE 100 may have the capability to support multicast reception in the RRC_INACTIVE state irrespective of whether the initial DL BWP has overlapping with the unicast dedicated active DL BWP configuration or the MBS CFR configuration or not. For example, the UE 100 may be equipped with multiple receiver capabilities. The UE 100 may indicate in the UE capability message about this capability flexibility or support to the network 110. The network can consider this capability information while determining whether to transition the UE 100 to the RRC_INACTIVE state. For example, the network 110 may readily transit the UE 100 to the RRC_INACTIVE state for multicast reception, and/or the network 110 may configure the unicast dedicated active DL BWP configuration or the MBS CFR configuration flexibly to the UE 100.

In an embodiment, upon receiving the frequency resource configuration for multicast reception in RRC_INACTIVE state, if the UE 100 reselects to a cell different than a serving cell associated with the network 110, then the UE 100 releases the frequency resource configuration for the multicast-bwp-inactive-config.

In an embodiment, UE which is configured/capable to receive multicast in the RRC_INACTIVE state is provided with at least one of the following BWP and/or CFR configurations to support multicast reception:
a) UE is provided with a BWP configuration for usage in the RRC_INACTIVE state for multicast reception which is the same as the unicast dedicated Active downlink BWP configuration the UE is utilizing to receive multicast session(s) in the RRC_CONNECTED state. UE monitors for Physical Downlink Control Channel (PDCCH) addressed by Group Radio Network Temporary Identifier (G-RNTI) or Group Configured Scheduling Radio Network Temporary Identifier (G-CS-RNTI) and/or receives Physical Downlink Shared Channel (PDSCH) addressed by G-RNTI or G-CS-RNTI over the unicast dedicated Active DL BWP for the relevant and interested multicast session(s) in the RRC_INACTIVE state.
b) UE is provided or signaled with the initial downlink BWP configuration for usage in the RRC_INACTIVE state for multicast reception. UE monitors for PDCCH addressed by G-RNTI or G-CS-RNTI and/or receives PDSCH addressed by G-RNTI or G-CS-RNTI over the initial downlink BWP for the relevant and interested multicast session(s) in the RRC_INACTIVE state.
c) UE is provided or signaled with the default downlink BWP configuration for usage in the RRC_INACTIVE state for multicast reception. UE monitors for PDCCH addressed by G-RNTI or G-CS-RNTI and/or receives PDSCH addressed by G-RNTI or G-CS-RNTI over the default downlink BWP for the relevant and interested multicast session(s) in the RRC_INACTIVE state.
d) UE is provided or signaled with the downlink MBS BWP configuration for usage in the RRC_INACTIVE state for multicast reception, which has the same resources as the MBS CFR configuration the UE is utilizing to receive multicast session(s) in the RRC_CONNECTED state. That is, the full unicast dedicated Active downlink BWP configuration is not monitored or utilized, and MBS BWP may be only the MBS CFR part of the unicast dedicated Active BWP. UE monitors for PDCCH addressed by G-RNTI or G-CS-RNTI and/or receives PDSCH addressed by G-RNTI or G-CS-RNTI over the MBS BWP/CFR for the relevant and interested multicast session(s) in the RRC_INACTIVE state.
e) UE is provided or signaled with the MBS CFR configuration for usage in the RRC_INACTIVE state for multicast reception, which is linked or associated with the initial downlink BWP. That is, MBS CFR may be larger or equal or less than the initial DL BWP. MBS CFR is indicated by providing the number of contiguous physical resource blocks (PRBs) and the starting PRB for the CFR. UE monitors for PDCCH addressed by G-RNTI or G-CS-RNTI and/or receives PDSCH addressed by G-RNTI or G-CS-RNTI over the MBS CFR associated with the initial downlink BWP for the relevant and interested multicast session(s) in the RRC_INACTIVE state.
f) UE is provided or signaled with the MBS CFR configuration for usage in the RRC_INACTIVE state for multicast reception, which is linked or associated to the unicast dedicated Active BWP used in the RRC_CONNECTED state. UE monitors for PDCCH addressed by G-RNTI or G-CS-RNTI and/or receives PDSCH addressed by G-RNTI or G-CS-RNTI over the MBS CFR associated to the unicast dedicated Active BWP for the relevant and interested multicast session(s) in the RRC_INACTIVE state.
g) UE is provided or signaled with the MBS CFR configuration for usage in the RRC_INACTIVE state for multicast reception, which is the same as being used for broadcast service reception for the UE and is linked or associated to the initial downlink BWP. That is, MBS CFR may be larger or equal or less than the initial DL BWP. UE monitors for PDCCH addressed by G-RNTI or G-CS-RNTI and/or receives PDSCH addressed by G-RNTI or G-CS-RNTI over the MBS CFR also used for broadcast for the relevant and interested multicast session(s) in the RRC_INACTIVE state.

In an embodiment, UE which is configured/capable to receive multicast in the RRC_INACTIVE state is provided the multicast session through broadcast delivery in the RRC_INACTIVE state. This may be required due to large number of UEs availing or interested to availing multicast services in the cell causing (potential) congestion in the network and network may decide to transit one or more UEs out of RRC_CONNECTED state and provide multicast service through broadcast delivery approach. That is, the multicast session is converted to the broadcast service when UE needs to be transitioned to RRC_INACTIVE and/or RRC_IDLE and is provided by reusing the broadcast delivery framework of the MBS (which includes System Information Block (SIB) or MBS Control Channel (MCCH) based broadcast signaling and configuration).

In an embodiment, if the UE is configured and/or capable to receive multicast in the RRC_INACTIVE state and the UE has only deactivated multicast session(s), the UE may be switched and/or operated in the initial DL BWP. That is, UE may continue monitoring for the group notification (or group paging) in the initial DL BWP. When UE receives group notification with activation of at least one interested multicast session, the UE is switched and/or operated to one of the aforementioned BWP or CFR configurations for multicast session reception in the RRC_INACTIVE state (refers to approaches “a” to “g” as described in the above embodiments). When UE receives group notification with the deactivation of the last activated multicast session and/or due to inactivity of the multicast data reception, the UE is switched and/or operated to the initial DL BWP.

In an embodiment, only unicast dedicated Active DL BWP or MBS CFR linked to unicast dedicated Active DL BWP is continued in the RRC_INACTIVE state, however, corresponding unicast dedicated Active UL BWP is not continued in the RRC_INACTIVE state (i.e., UE does not maintain the dedicated Active UL BWP and rather UL transmissions e.g., PRACH transmission, can be performed in the initial UL BWP.

In an embodiment, both unicast dedicated Active DL BWP or MBS CFR linked to unicast dedicated Active DL BWP and corresponding unicast dedicated Active UL BWP are continued in the RRC_INACTIVE state (i.e., UE also maintains the dedicated Active UL BWP and UL transmissions e.g., PRACH transmission, or HARQ feedback, if any, can be performed in the Active UL BWP).

In an embodiment, UE availing multicast in the RRC_INACTIVE state may also need to access the floor (e.g. for Mission-Critical Push-to-Talk service) and transmit traffic in uplink direction. For this purpose, UE may initiate a PRACH transmission to the network and quickly resume the RRC connection and come to RRC_CONNECTED state. If the PRACH occasions are configured and utilized on the Active UL BWP, network gets notified of the need of the multicast UE and address the request for RRC state transition promptly and reliably. If the PRACH occasions are not configured on the Active UL BWP, UE does PRACH on the initial UL BWP.

In an embodiment, UE can use at least one of a pre-specified or a special preamble to indicate to the network the need to access the floor and transmit multicast traffic in uplink direction. Network can therefore address the request for RRC state transition promptly and reliably.

Embodiments of the present invention will be described below in detail with reference to the accompanying drawings.

In an embodiment, UE may be switched across different BWP/CFR (e.g., among different configurations as mentioned in approaches “a” to “g” earlier) by indicating the newly applicable BWP identity or CFR identity or the number of contiguous physical resource blocks (PRBs) and the starting PRB for the CFR in the PDCCH through DCI signaling.

In an embodiment, the frequency domain resources and time domain resources are dynamically allocated in the Physical Downlink Control Channel (PDCCH) Downlink Control Information (DCI), for the multicast reception in the RRC_INACTIVE state. For example, a scheduling DCI format 4_1 used in the RRC_CONNECTED state is reused for the UE in the RRC_INACTIVE state. Further, UE receiving multicast in RRC_INACTIVE may not apply certain dedicated parameters signaled in the received DCI format 4_1 which the UE receiving multicast in RRC_CONNECTED may apply (e.g., at least one parameter of PUCCH resource indicator, PDSCH-to-HARQ_feedback timing indicator, Downlink assignment index may not be utilized by UE in RRC_INACTIVE). The allocated resources are mapped to one of the aforementioned BWP or CFR configurations as applicable for multicast session reception in the RRC_INACTIVE state (refer to approaches “a” to “g” mentioned earlier).

In an embodiment, UE may have the capability to support multicast reception in the RRC_INACTIVE state only if Initial DL BWP has overlapping with the unicast dedicated Active DL BWP or MBS CFR (e.g. UE has a limitation to receive one BWP at a time). UE may indicate in the UE capability message about this capability limitation or support to the network. The network can consider this capability information while determining UE to transition to the RRC_INACTIVE state (e.g. network may not transit this UE to RRC_INACTIVE for multicast reception, and/or the network configures unicast dedicated Active DL BWP or MBS CFR appropriately to the UE). Further, UE may initiate an RRC connection resume request when it sees such a limited configuration in the RRC_INACTIVE state, and transition to the RRC_CONNECTED state and/or send an indication for UE's multicast interest or information to the network by a signaling message e.g., MBS interest indication or UE assistance information message.

In an embodiment, UE may have the capability to support multicast reception in the RRC_INACTIVE state irrespective of whether Initial DL BWP has overlapping with the unicast dedicated Active DL BWP or MBS CFR or not. For example, UE may be equipped with multiple Receiver capabilities. UE may indicate in the UE capability message about this capability flexibility or support to the network. The network can consider this capability information while determining UE to transition to the RRC_INACTIVE state (e.g. network may readily transit this UE to RRC_INACTIVE for multicast reception, and/or the network configures unicast dedicated Active DL BWP or MBS CFR flexibly to the UE).

In an embodiment, a UE is configured for the multicast reception in the RRC_INACTIVE state by providing relevant BWP or CFR configuration by the network through RRC signaling that may include at least one of the RRC reconfiguration message (e.g. reuse of RRC reconfiguration parameters for RRC_INACTIVE or comprising specifically indicated parameters in the message for reuse in RRC_INACTIVE or a reduced set of parameters provided specifically for RRC_INACTIVE) or RRCRelease with SuspendConfig message or broadcasted signaling message comprising at least one of System Information Block (SIB) or MBS Control Channel (MCCH) message. The configuration (e.g., may be termed as multicast-bwp-inactive-config) may include at least one of TDD UL-DL configuration, initial DL BWP, Active DL BWP, default DL BWP, initial UL BWP, Active UL BWP, PRACH occasions or configurations, multicast-bwp-inactivityTimer, slot format indicator, number of HARQ processes, the number of contiguous physical resource blocks (PRBs) and the starting PRB for the CFR. The message may also include the indication or configuration (MBS radio bearer configuration) for the multicast session(s) which are to be continued in the RRC_INACTIVE state and/or multicast sessions which are to be released (i.e. not continued in RRC_INACTIVE state) and/or multicast sessions which are to be modified (i.e. one or more configuration parameters for these multicast session(s) are changed for reception in RRC_INACTIVE state).

In an embodiment, if the UE reselects to a different cell (i.e., a cell different than the serving cell or a cell outside the multicast session coverage area or to a cell having a different BWP/CFR) than a cell where the configuration for the multicast-bwp-inactive-config is received, UE releases the configuration for the multicast-bwp-inactive-config. In an embodiment, further, UE initiates a RRC connection resume procedure to move to RRC_CONNECTED state in order to avail the multicast session.

In an embodiment, if the UE reselects to a cell different than a serving cell associated with the network and the reselected cell does not provide configuration for the multicast session reception in the RRC_INACTIVE state that the UE has joined, the UE initiates a RRC connection resume procedure to move to RRC_CONNECTED state in order to avail the multicast session.

In another embodiment, if the UE 100 reselects to a cell that is in the same radio access network-based notification area (RNA) as the cell where the configuration for the multicast-bwp-inactive-config is received, the UE 100 may keep the configuration for the multicast-bwp-inactive-config. That is, the UE 100 does not release the configuration for the multicast-bwp-inactive-config.

In another embodiment, the configuration for the multicast-bwp-inactive-config is released when the UE 100 receives an RRC setup message in response to an RRCReestablishmentRequest or an RRCResumeRequest, or an RRCResumeRequest1 message.

In another embodiment, the configuration for the multicast-bwp-inactive-config is released when the UE 100 receives an RRCResume message in response to the RRCResumeRequest or the RRCResumeRequest1 message.

In an embodiment, for UE which is configured to receive multicast in the RRC_INACTIVE state over a BWP/CFR, if a BWP/CFR is active in RRC_INACTIVE, the UE 100 performs at least one of the following:
a) refraining from transmitting on an Uplink Shared Channel (UL-SCH) on the BWP/CFR;
b) refrain from transmitting PRACH on the BWP (UE may transmit PRACH on initial UL BWP/CFR);
c) refraining from transmitting physical uplink control channel (PUCCH) on the BWP/CFR;
d) refraining from reporting a channel state information (CSI) for the BWP/CFR;
e) refraining from transmitting a sounding reference signal (SRS) on the BWP/CFR; and
f) receiving DL-SCH on the BWP/CFR.

In an embodiment, for UE which is configured to receive multicast in the RRC_INACTIVE state over a BWP/CFR, if the BWP/CFR is deactivated in the RRC_INACTIVE, the UE 100 performs at least one of the following:
a) refraining from transmitting on an Uplink Shared Channel (UL-SCH) on the BWP;
b) refrain from transmitting PRACH on the BWP (UE may transmit PRACH on an initial UL BWP);
c) refraining from transmitting PUCCH on the BWP;
d) refraining from reporting a CSI for the BWP;
e) refraining from transmitting an SRS on the BWP;
f) refraining from receiving DL-SCH on the BWP; and
g) clearing any configured downlink assignment on the BWP.

In an embodiment, for the UE 100 which is configured to receive the multicast sessions in the RRC_INACTIVE state over a BWP/CFR, if BWP/CFR is deactivated in the RRC_INACTIVE state, the UE 100 may initiate an RRC connection Resume procedure by sending an RRCResumeRequest or RRCResumeRequest/1 in order to transit to the RRC_CONNECTED state to avail multicast session and/or to send an MBS interest indication or UE assistance information message to the network 110 and/or to formally release the multicast session. Alternatively, the UE 100 may inform the upper layers about the deactivation of the BWP/CFR, and/or termination of the multicast session in the RRC_INACTIVE state and cease the multicast session.

In an embodiment, UE which is configured to receive multicast in RRC_INACTIVE and/or receiving multicast in RRC_INACTIVE, is configured with the multicast-bwp-inactivityTimer (e.g. in the frequency resource configuration). In an embodiment, the configuration for the inactivity timer (multicast-bwp-inactivityTimer) may be signaled through the RRC signaling that may include but not limited to the RRC Reconfiguration message and/or RRC Release with suspend configuration. In an embodiment, the configuration of multicast-bwp-inactivityTimer may be signaled in system information or MCCH. In another embodiment, the configuration for a [symbol] wp-inactivity Timer for the relevant unicast BWP to which the MBS CFR carries the multicast transmission in the RRC_CONNECTED state is reused for the multicast-bwp-inactivity Timer operation in the RRC_INACTIVE state. In another embodiment, UE continues to use the “bwp-inactivity Timer” for the relevant unicast BWP to which the MBS Common Frequency Resource (CFR) carries the multicast transmission in the RRC_INACTIVE state. This may be in at least one of the cases of UE which is configured to receive multicast in RRC_INACTIVE and UE receiving multicast in RRC_INACTIVE. Accordingly, the UE 100 continues to use the “bwp-inactivity Timer” for the relevant unicast BWP in the RRC_INACTIVE state.

In an embodiment, the multicast-bwp-inactivityTimer is started when the UE 100 transitions to the RRC_INACTIVE state from the RRC_CONNECTED state and at least one of: the UE 100 is configured to receive multicast service in the RRC_INACTIVE state (i.e., irrespective of the activated or non-activated state of one or more relevant MBS multicast session(s)) or the UE 100 starts/continues receiving one or more relevant MBS multicast session(s) in the RRC_INACTIVE state.

In another embodiment, multicast-bwp-inactivityTimer is started or restarted when UE in the RRC_INACTIVE receives a group notification message (e.g. a group paging activating at least one interested multicast session for reception in RRC_INACTIVE). In other words, the multicast-bwp-inactivity Timer is started or restarted when the UE 100 in the RRC_INACTIVE state receives a group paging or a group notification activating at least one interested MBS multicast session from the one or more relevant MBS multicast sessions for reception in the RRC_INACTIVE state.

In another embodiment, the multicast-bwp-inactivityTimer is started or restarted when the UE 100 in the RRC_INACTIVE receives a PDCCH indicating a downlink assignment addressed by the G-RNTI and/or the G-CS-RNTI for the at least one interested multicast session reception in the RRC_INACTIVE, i.e., for the reception of at one interested MBS multicast session from the one or more interested MBS multicast sessions in the RRC_INACTIVE state.

In another embodiment, the multicast-bwp-inactivity Timer is started or restarted when the UE 100 in the RRC_INACTIVE state receives a medium access control protocol data unit (MAC PDU) in a configured downlink assignment for the at least one interested MBS multicast session reception in the RRC_INACTIVE state.

In another embodiment, if the multicast-bwp-inactivityTimer expires in the RRC_INACTIVE state, the UE 100 switches its BWP/CFR of reception to the initial DL BWP. In particular, the UE 100 may receive a transmission from the network in an initial DL BWP upon the expiry of the multicast-bwp-inactivity Timer.

In another embodiment, when the UE 100 switches its active DL BWP in the RRC_INACTIVE state (e.g., when receiving a PDCCH indicating a change of BWP) and the new BWP is not the default DL BWP, if configured, or the initial DL BWP, then the UE 100 starts or restarts the multicast-bwp-inactivityTimer.

In an embodiment, if the multicast-bwp-inactivity Timer expires in the RRC_INACTIVE state, the UE 100 switches its BWP/CFR of reception to the default DL BWP, if configured. Further, if the default DL BWP is not configured, the UE 100 switches its BWP/CFR of reception to the initial DL BWP.

In an embodiment, if the multicast-bwp-inactivityTimer expires in the RRC_INACTIVE state, the UE 100 transitions from the RRC_INACTIVE state to the RRC_IDLE state.

In an embodiment, if the multicast-bwp-inactivity Timer expires in the RRC_INACTIVE state, the UE 100 transitions from the RRC_INACTIVE state to the RRC_CONNECTED state.

In an embodiment, the multicast-bwp-inactivityTimer is stopped and/or reset when the UE 100 receives an RRC setup message in response to the RRCReestablishmentRequest or the RRCResumeRequest, or the RRCResumeRequest1 message.

In a further embodiment, the multicast-bwp-inactivity Timer is stopped and/or reset when the UE 100 receives the RRCResume message in response to the RRCResumeRequest or the RRCResumeRequest1 message.

In a further embodiment, if the UE 100 reselects to a different cell (or a cell outside the multicast session coverage area or to a cell having a different BWP/CFR) than the cell where the configuration for the multicast-bwp-inactivityTimer is received, the UE 100 stops and/or resets the multicast-bwp-inactivityTimer and/or releases the configuration for the multicast-bwp-inactivityTimer.

In an embodiment, if the UE 100 reselects to a cell that is in the same Radio Access Network based Notification Area (RNA) to the cell where the configuration for the multicast-bwp-inactivityTimer is received, the UE 100 stops and/or resets the multicast-bwp-inactivityTimer and/or releases the configuration for the multicast-bwp-inactivityTimer.

In an embodiment, if the UE 100 transits from the RRC_INACTIVE state to the RRC_CONNECTED state (e.g., upon receiving an RRCSetup message or receiving an RRCResume message or receiving a group notification causing RRC state change), the UE 100 stops and/or resets multicast-bwp-inactivityTimer and/or releases the configuration for the multicast-bwp-inactivityTimer.

In an embodiment, if the UE 100 transits from the RRC_INACTIVE state to the RRC_IDLE state (e.g., upon receiving an RRCRelease message or expiry of inactivity timer or termination of all multicast sessions), the UE 100 stops and/or resets the multicast-bwp-inactivityTimer and/or releases the configuration for the multicast-bwp-inactivityTimer.

In an embodiment, if the BWP with which MBS multicast session CFR is associated, and where the UE 100 is configured to receive multicast in the RRC_INACTIVE state, becomes inactive BWP or becomes dormant or indicated as dormant BWP, the UE 100 stops the multicast-bwp-inactivity Timer.

In an embodiment, if the BWP to which multicast session CFR configuration is associated, and where the UE 100 is configured to receive or is receiving multicast in the RRC_INACTIVE is switched (i.e., a PDCCH for BWP switching is received and the UE 100 switches active DL BWP), the UE 100 starts or restarts the multicast-bwp-inactivityTimer associated with the active DL BWP.

In an embodiment, if the UE 100 receives a group paging or a notification (e.g. in MCCH) deactivating the one or more relevant MBS multicast sessions for reception in the RRC_INACTIVE state, the UE 100 stops and/or resets the multicast-bwp-inactivity Timer and/or releases the configuration for the multicast-bwp-inactivityTimer.

In an embodiment, in the RRC_INACTIVE state, upon initiation of the random-access procedure on the serving cell, after the selection of carrier for performing the Random Access procedure, the UE 100 stops the multicast-bwp-inactivity Timer.

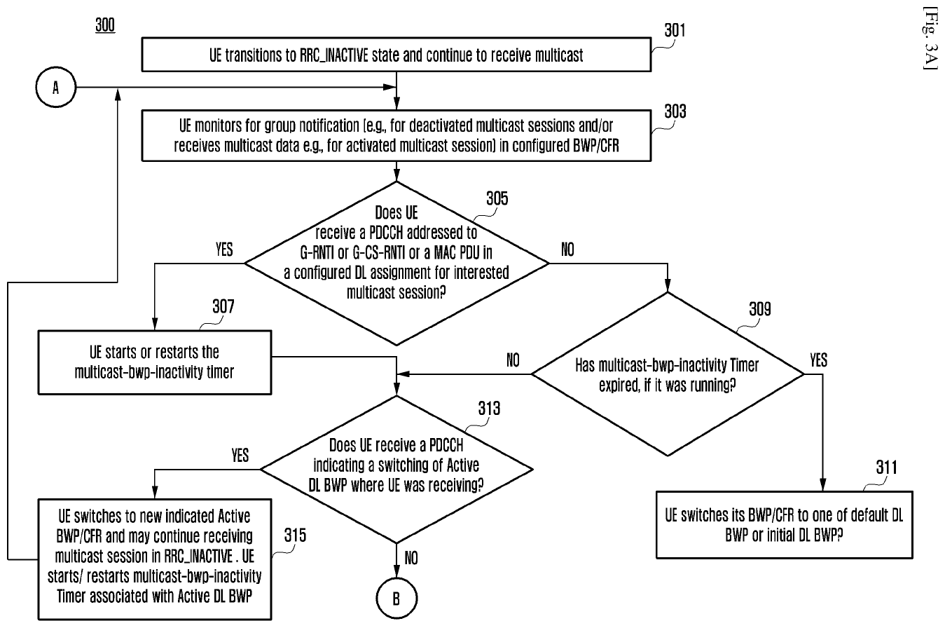

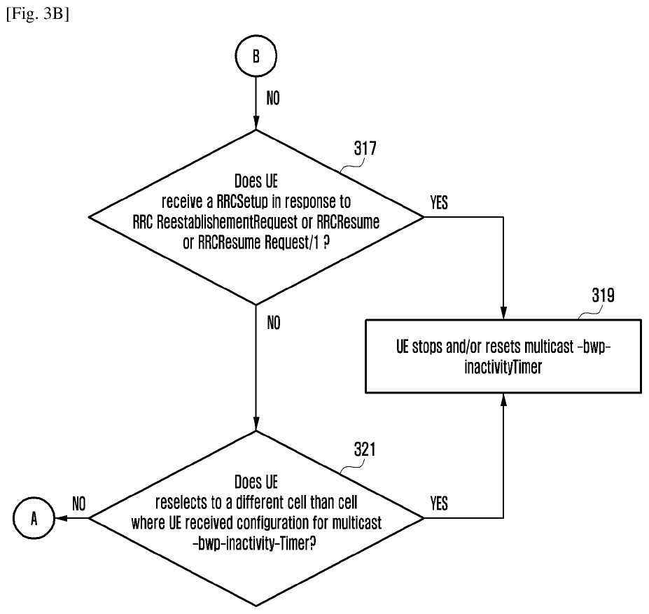

The behaviour of the UE 100 in the RRC_INACTIVE state when the frequency resource configuration includes the multicast-bwp-inactivity Timer, is further explained in reference to FIGS. 3A-3B. FIG. 3A-3B illustrate an operational flow for the inactivity timer (multicast-bwp-inactivityTimer) management for the MBS multicast reception in the RRC_INACTIVE state, in accordance with an embodiment of the present disclosure.

As shown in FIG. 3A, at step 301, the UE 100 transitions to the RRC_INACTIVE state and continues to receive the multicast session(s).

At step 303, the UE 100 monitors group notifications for deactivated multicast sessions and/or receives multicast data for an activated multicast session in the configured BWP or CFR.

At step 305, the UE 100 determines whether a PDCCH is received addressed to one of G-RNTI, G-CS-RNTI, for an interested multicast session, or a MAC PDU is received in a configured DL assignment for an interested multicast session. If a result of the determination at the step 305 is yes, then the method 300 proceeds to step 307.

At step 307, the UE 100 starts or restarts the multicast-bwp-inactivity Timer.

However, if a result of the determination at the step 305 is No, then the method 300 proceeds to step 309. At step 309, the UE 100 determines whether the multicast-bwp-inactivityTimer has been expired or is still running. If a result of the determination at the step 309 is yes, then the method 300 proceeds to step 311.

At step 311, the UE 100 switches its BWP/CFR to one of the default DL BWP or the initial DL BWP. However, if a result of the determination at the step 309 is No, then the method 300 proceeds to step 313. At step 313, the UE 100 determines whether the PDCCH indicating switching of a new Active DL BWP is received from the network 110. If a result of the determination at the step 313 is yes, then the method 300 proceeds to step 315.

At step 315, the UE 100 switches to the newly indicated Active DL BWP and continues to receive the multicast session in the RRC_INACTIVE state and the UE 100 may also start or restart multicast-bwp-inactivityTimer associated with the newly indicated Active DL BWP. After the restart of the multicast-bwp-inactivity Timer, the UE 100 may again perform step 303 to step 315 until a result of the determination at the step 313 becomes No. If a result of the determination at the step 313 is No, then the method 300 proceeds to step 317.

As shown in FIG. 3B, at step 317, the UE 100 determines whether an RRC setup request is received by the UE 100 from the network 110 in response to one of an RRC re-establishment request, an RRC resume request, or an RRC resume request/1. If a result of the determination at the step 317 is Yes, then the method 300 proceeds to step 319.

At step 319, the UE 100 stops the multicast-bwp-inactivityTimer or resets the multicast-bwp-inactivityTimer. However, if a result of the determination at the step 317 is No, then the method 300 proceeds to step 321.

In step 321 of method 300, the UE 100 determines whether a different cell is reselected in comparison to the cell where the UE 100 has received the configuration from the network 110 for the multicast-bwp-inactivityTimer. If a result of the determination at the step 321 is yes, then the UE 100 performs the step 319 again.

However, if a result of the determination at the step 331 is No, then the UE 100 may again perform step 303 to step 321 until a result of the determination at the step 331 becomes Yes.

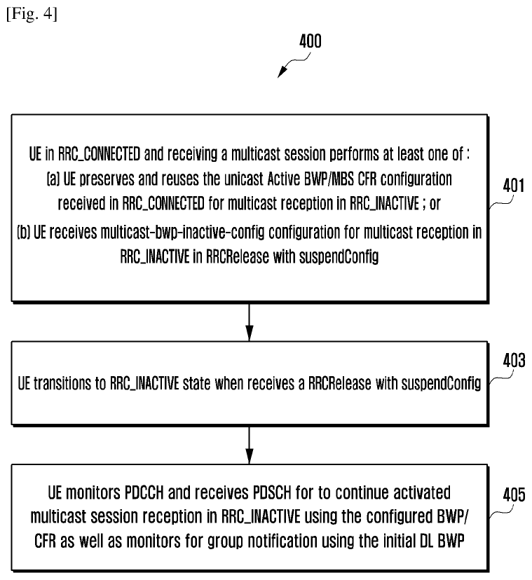

A configuration example for the BWP/CFR for the multicast reception in the RRC_INACTIVE state, in accordance with an embodiment of the present disclosure, is described with reference to FIG. 4. FIG. 4 depicts a method 400 for the operation of the BWP/CFR for multicast reception in the RRC_INACTIVE state. As shown in FIG. 4, at step 401 of the method 400, the UE 100 is receiving a multicast session in the RRC_CONNECTED state from the network 110. The UE 100 receives the unicast active BWP or MBS CFR configuration from the network 110 in the RRC CONNECTED state. Further, the UE 100 may preserve and reuse one of the received unicast active BWP or the received MBS CFR configuration for multicast reception in the RRC_INACTIVE state, or the UE 100 may receive the multicast-bwp-inactive-config from the network 110 for multicast reception in RRCRelease with SuspendConfig message.

At step 403 of the method 400, the UE 100 transitions to the RRC_INACTIVE state when the RRCRelease with suspendConfig message is received by the UE 100 from the network 100 in the RRC_CONNECTED state.

At step 405 of the method 400, after the UE 100 is transitioned to the RRC_INACTIVE state, the UE 100 may monitor the PDCCH and receives the PDSCH to continue the activated multicast session reception in the RRC_INACTIVE state using the configured BWP or CFR, and/or, the UE 100 may monitor for group paging and/or group notification using the initial downlink BWP (DL BWP).

In an exemplary embodiment, FIG. 5 illustrates a signal flow diagram of an exemplary method for receiving multicast service in the RRC_INACTIVE state using the frequency resource configuration. As shown in FIG. 5, at step 1, the UE 100 is in the RRC_CONNECTED state and is receiving multicast sessions X and Y (i.e., sessions X, Y and Z are in activated state). At step 2 of FIG. 5, the UE 100 receives dedicated signalling from network 110 i.e., the RRC reconfiguration message with MBS radio bearer (MRB) release conveying “session deactivation” for session Y. The UE 100 releases the MRB for session Y. Session Y is now in the deactivated state. At step 3 of FIG. 5, the UE 100 receives RRC Release with suspendConfig that carries the configuration for multicast reception to be continued in the RRC_INACTIVE state and/or configuration for multicast-bwp-Inactivity-Timer for session X and/or Y. The UE 100 stores the configuration for sessions X and/or Y. At step 4 of FIG. 5, the UE 100 transits to the RRC_INACTIVE state from the RRC_CONNECTED state. The UE 100 switches to the BWP/CFR for multicast reception in the RRC_INACTIVE state.

At step 5 of FIG. 5, the multicast session X is active in the RRC_INACTIVE state. The UE 100 starts/restarts and operates the multicast-bwp-inactivityTimer for session X. At step 6 of FIG. 5, the UE 100 receives a multicast group notification or group paging conveying session Y activation and/or other events. The UE 100 determines based on channel condition (e.g., poor signal conditions) and/or signalling (e.g., RRC state is indicated as the RRC_CONNECTED state in the group paging) to continue in the RRC_INACTIVE state or go to the RRC_CONNECTED state. At step 7 of FIG. 5, the UE 100 starts/restarts and operates the multicast-bwp-inactivityTimer for session Y. At step 8 of FIG. 5, the UE 100 configures and restores the multicast MRB for session Y in the RRC_INACTIVE state. Now sessions X and Y are active in the RRC_INACTIVE state. The UE 100 operates the multicast-bwp-inactivity Timer for sessions X and/or Y (e.g., restart on receiving a multicast packet). At step 9 of FIG. 5, the UE 100 receives the multicast group notification or group paging conveying session X deactivation. Accordingly, the UE 100 stops multicast-bwp-inactivityTimer for session X. At step 10 of FIG. 5, if the multicast-bwp-inactivity Timer expires, the UE 100 switches to BWP/CFR of reception to the initial BWP or the UE 100 switches to the RRC_CONNECTED state. At step 11 of FIG. 5, if the UE 100 performs cell reselection to a different cell or a cell outside the multicast session coverage or a cell having different BWP/CFR), the UE 100 releases the configuration for the BWP/CFR for multicast reception. Accordingly, the UE 100 may initiate an RRC connection resume to move to the RRC_CONNECTED state. At step 12 of FIG. 5, the UE 100 receives the multicast group notification (e.g., the group paging) conveying session X activation and/or other events. Accordingly, the UE 100 determines based on channel condition (e.g., poor signal conditions) and/or signalling (e.g., RRC state is indicated as the RRC_CONNECTED state in group paging) to continue in the RRC_INACTIVE state or go to the RRC_CONNECTED state. At step 13 of FIG. 5, to continue in the RRC_CONECTED state, the UE 100 sends an RRC Resume Request to the network 110. At step 14 of FIG. 5, the UE 100 receives the RRC Resume or Setup message from the network 100 and the UE 100 transits to the RRC_CONNECTED state. The UE 100 releases the BWP/CFR configuration for multicast reception in the RRC_INACTIVE state. The UE 100 releases configuration for the multicast-bwp-inactivity Timer for sessions X and/or Y. At step 15 of FIG. 5, the UE 100 receives dedicated signalling from the network in the RRC_CONNECTED state i.e., the RRC reconfiguration message with MRB setup conveying “session activation” for the session X. Accordingly, at step 16 of FIG. 5, the multicast session X and/or Y is now active in the RRC_CONNECTED state. This way the UE 100 may receive the multicast session in the RRC_INACTIVE state using the frequency resource configuration.

Accordingly, the present disclosure discloses the techniques that address frequency resource configurations and operational aspects for multicast reception in the RRC_INACTIVE state. This way frequency resource configurations may be provided in the RRC_INACTIVE state also.

Unless otherwise defined, all technical and scientific terms used herein have the same meaning as commonly understood by one of ordinary skilled in the art to which this invention belongs. The system, methods, and examples provided herein are illustrative only and not intended to be limiting.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

While specific language has been used to describe the present subject matter, any limitations arising on account thereto, are not intended. As would be apparent to a person in the art, various working modifications may be made to the method in order to implement the inventive concept as taught herein. The drawings and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment.

1-15. (canceled)

16. A method performed by a user equipment (UE) supporting a multicast broadcast service (MBS) in a wireless communication system, the method comprising:
receiving, from a base station in a radio resource control (RRC) connected state, MBS multicast session configuration information for receiving an MBS multicast service in an RRC inactive state and multicast channel configuration information associated with a common frequency resource (CFR) for receiving the MBS multicast service in the RRC inactive state;
receiving, from the base station, downlink control information (DCI) scrambled by a group-radio network temporary identifier (G-RNTI); and
based on the MBS multicast session configuration information, the multicast channel configuration information, and the DCI, receiving, from the base station, a physical downlink shared channel (PDSCH) for the MBS multicast service in the RRC inactive state.

17. The method of claim 16, wherein the multicast channel configuration information associated with the CFR is received via an RRC release message with suspend configuration information or a system information block (SIB).

18. The method of claim 16, wherein the multicast channel configuration information associated with the CFR includes bandwidth information indicating a starting physical resource block (PRB) and a number of PRBs of the CFR, and
wherein a bandwidth part (BWP) of the CFR is larger than or equal to an initial BWP.

19. The method of claim 16, wherein a hybrid automatic repeat request (HARQ) field in the DCI is ignored for receiving the MBS multicast service in the RRC inactive state.

20. The method of claim 16, further comprising receiving, from the base station, a multicast-BWP-inactivity timer via an RRC message,
wherein the multicast-BWP-inactivity timer starts when the UE in the RRC inactive state receives a group notification message, and
wherein the multicast-BWP-inactivity timer is stopped when the UE receives an RRC setup message.

21. A method performed by a base station supporting a multicast broadcast service (MBS) in a wireless communication system, the method comprising:
transmitting, to a user equipment (UE), MBS multicast session configuration information for transmitting an MBS multicast service in a radio resource control (RRC) inactive state and multicast channel configuration information associated with a common frequency resource (CFR) for transmitting the MBS multicast service in the RRC inactive state;
transmitting, to the UE, downlink control information (DCI) scrambled by a group-radio network temporary identifier (G-RNTI); and
based on the MBS multicast session configuration information, the multicast channel configuration information, and the DCI, transmitting, to the UE in the RRC inactive state, a physical downlink shared channel (PDSCH) for the MBS multicast service.

22. The method of claim 21, wherein the multicast channel configuration information associated with the CFR is transmitted via an RRC release message with suspend configuration information or a system information block (SIB).

23. The method of claim 21, wherein the multicast channel configuration information associated with the CFR includes bandwidth information indicating a starting physical resource block (PRB) and a number of PRBs of the CFR, and
wherein a bandwidth part (BWP) of the CFR is larger than or equal to an initial BWP.

24. The method of claim 21, wherein a hybrid automatic repeat request (HARQ) field in the DCI is ignored for receiving the MBS multicast service in the RRC inactive state.

25. The method of claim 21, further comprising transmitting, to the UE, a multicast-BWP-inactivity timer via an RRC message,
wherein the multicast-BWP-inactivity timer starts when the base station transmits a group notification message, and
wherein the multicast-BWP-inactivity timer is stopped when the base station transmits an RRC setup message.

26. A user equipment (UE) supporting a multicast broadcast service (MBS) in a wireless communication system, the UE comprising:
a transceiver; and
a controller coupled with the transceiver, and configured to:
receive, from a base station in a radio resource control (RRC) connected state, MBS multicast session configuration information for receiving an MBS multicast service in an RRC inactive state and multicast channel configuration information associated with a common frequency resource (CFR) for receiving the MBS multicast service in the RRC inactive state,
receive, from the base station, downlink control information (DCI) scrambled by a group-radio network temporary identifier (G-RNTI), and
based on the MBS multicast session configuration information, the multicast channel configuration information, and the DCI, receive, from the base station, a physical downlink shared channel (PDSCH) for the MBS multicast service in the RRC inactive state.

27. The UE of claim 26, wherein the multicast channel configuration information associated with the CFR is received via an RRC release message with suspend configuration information or a system information block (SIB).

28. The UE of claim 26, wherein the multicast channel configuration information associated with the CFR includes bandwidth information indicating a starting physical resource block (PRB) and a number of PRBs of the CFR, and
wherein a bandwidth part (BWP) of the CFR is larger than or equal to an initial BWP.

29. The UE of claim 26, wherein a hybrid automatic repeat request (HARQ) field in the DCI is ignored for receiving the MBS multicast service in the RRC inactive state.

30. The UE of claim 26, wherein the controller is further configured to receive, from the base station, a multicast-BWP-inactivity timer via an RRC message,
wherein the multicast-BWP-inactivity timer starts when the UE in the RRC inactive state receives a group notification message, and
wherein the multicast-BWP-inactivity timer is stopped when the UE receives an RRC setup message.

31. A base station supporting a multicast broadcast service (MBS) in a wireless communication system, the base station comprising:
a transceiver, and
a controller coupled with the transceiver, and configured to:
transmit, to a user equipment (UE), MBS multicast session configuration information for transmitting an MBS multicast service in a radio resource control (RRC) inactive state and multicast channel configuration information associated with a common frequency resource (CFR) for transmitting the MBS multicast service in the RRC inactive state,
transmit, to the UE, downlink control information (DCI) scrambled by a group-radio network temporary identifier (G-RNTI), and
based on the MBS multicast session configuration information, the multicast channel configuration information, and the DCI, transmit, to the UE in the RRC inactive state, a physical downlink shared channel (PDSCH) for the MBS multicast service.

32. The base station of claim 31, wherein the multicast channel configuration information associated with the CFR is transmitted via an RRC release message with suspend configuration information or a system information block (SIB).

33. The base station of claim 31, wherein the multicast channel configuration information associated with the CFR includes bandwidth information indicating a starting physical resource block (PRB) and a number of PRBs of the CFR, and
wherein a bandwidth part (BWP) of the CFR is larger than or equal to an initial BWP.

34. The base station of claim 31, wherein a hybrid automatic repeat request (HARQ) field in the DCI is ignored for receiving the MBS multicast service in the RRC inactive state.

35. The base station of claim 31, wherein the controller is further configured to transmit, to the UE, a multicast-BWP-inactivity timer via an RRC message,
wherein the multicast-BWP-inactivity timer starts when the base station transmits a group notification message, and
wherein the multicast-BWP-inactivity timer is stopped when the base station transmits an RRC setup message.
